(19) United States
(12) Patent Application Publication
(10) Pub. No.: US 2008/0112339 A1
(43) Pub. Date: May 15, 2008

(54) Full service mobile wireless telecommunication system and method

(76) Inventors: Christopher Armstrong, Simpsonville, SC (US); John R. Perkins, Greenville, SC (US)

Correspondence Address: MCNAIR LAW FIRM, P.A., P.O. BOX 10827, GREENVILLE, SC, 29603-0827, US

(21) Appl. No.: 11/595,462

(22) Filed: Nov. 9, 2006

(51) Int. Cl. H04M 3/42; H04B 7/14

(52) U.S. Cl. 370/271; 370/315

(57) ABSTRACT

A system and method is provided to allow users in a remote location, such as a construction site, to both send and receive telephone calls, radio transmissions, and data without directly connecting to the plain old telephone system (POTS). The wireless telephone and data system is a rugged, portable, integrated system comprising an external gateway, WiFi network host, and Internet protocol-enabled telephone unit. When connected to an AC power source in the remote location, the system connects a variety of wireless devices to telephone, radio phone, cellular, and Internet access to facilitate communication of telephone calls, radio calls, and data transfer both internally and with the outside world.

### BACKGROUND OF THE INVENTION

The invention relates to a wireless communication system and, more particularly, to a system that may be transported to different work sites and installed without the need of hard-wired incoming telephone and data lines or interim lines, yet provides full telephone and data communications.

Telephone and data systems have changed a great deal since the inception of the plain old telephone system (POTS). But communication from remote locations remains substantially unchanged. Groups of people wishing to communicate by radio and telephone in remote or off-site locations, such as a large construction site, generally find that doing so requires use of multiple independent systems, involving costly and delayed installation of hard-wired outside connections by a local telephone service provider. In fact, such applications exist anywhere one might need a telephone or data system, such as offsite offices, fund raiser events, festivals, offsite meetings, conventions, or the like.

Perhaps the best example of such an application and its attendant difficulties is found in the construction industry, where construction companies often have to delay project startup dates until the Regional Bell Operating Company (RBOC) installs outside cable to the construction site trailer. The RBOC engineering fees for these lines can be substantial at each site. When the project is completed the lines are disconnected and the outside cable is generally left behind. This results in a loss of investment to the construction company.

In addition, recent national events have shown that businesses in America must be ready for potential disasters and what loss of telephone and data service might mean to their day-to-day business operations. Many businesses have had to close their doors due to loss of revenue during the down time resulting from such disasters.

Modern communications technology, however, provides numerous ways for people to place and receive telephone calls, faxes, email, and the like. The concept of radio communication in a local area using walkie-talkies is also well-known. With the advent of cellular and Internet protocol (IP) technology, telephone systems may be configured to operate remotely and without connecting directly to the POTS. Traditional telephone systems, by contrast, require connection to the POTS and are generally inflexible and expensive. Up-front planning, installation, and connection of a complete telephone and data system at a large construction site, for example, represents significant costs to a builder and often hampers efficient system upgrades and changes. Costs increase still further when construction is complete and the specially-designed system is simply abandoned as unsuitable for re-use or transport.

Moreover, wireless commercial systems, as they now exist, require integration of various communication systems and ultimately a separate connection to the POTS, local cellular provider, a private branch exchange (PBX), or the like. Currently available systems do not provide complete communications capability in a portable, rugged, and completely self-contained unit capable of providing full telephone and data communication in remote locations.

U.S. Pat. No. 6,751,462 to Torrey et al. and U.S. Patent Application No. 2002/0068529 to Knoble disclose systems and methods for using traditional telephones to make cellular calls. U.S. Pat. No. 6,591,114 to Inbody discloses a fixed cellular interface unit that enables a PBX or key system unit to operate with a cellular transceiver. U.S. Pat. No. 6,999,761 to Bacon et al. discloses a fixed wireless telephone device that allows a POTS system to place and receive calls through a wireless communications network. None of these systems, however, provide complete communications capability in a portable, rugged, and completely self-contained unit capable of providing full telephone and data communication in remote locations. What is needed is a portable telephone and data system that overcomes these limitations so as to allow remote users full access to voice and data communications using cellular, IP, and wireless devices that connect to a single portable system rugged enough to operate in primitive or harsh locations.

Accordingly, an object of the present invention to provide a mobile wireless communication system that may be easily and safely transported to different site locations to provide users with multiple types of wireless devices the ability to wirelessly communicate at the site location using modern cellular, IP, and radio gateways and systems.

Other objects and benefits of the present invention will become apparent from the detailed description when taken in conjunction with the drawings provided.

### SUMMARY OF THE INVENTION

The foregoing objects have been achieved in the present invention, whereby the present invention overcomes the above identified and other deficiencies in conventional wireless telephone systems by providing a rugged, portable, integrated system and method to allow users to send and receive telephone calls, radio transmissions, and data in a remote location.

The above objectives may be accomplished according to the present invention by providing an integrated telecommunication system that may be transported to and setup at remote locations for wirelessly providing telephone, radio phone, and data service from the outside world. The system comprises a portable housing and an Internet protocol-enabled phone unit (IP phone unit) disposed in the housing. An external gateway is connected to the IP phone unit for wirelessly communicating telephone calls, radio phone calls, and data transmissions to and from the IP phone unit. A WiFi network host is disposed in the housing and connected to the IP phone unit. A wireless access point (WAP) is provided, where necessary, for communicating the telephone calls, radio phone calls, and data transmissions to and from the WiFi network host. A user device is connected to the WiFi network host either directly, using its own wireless connection means, or indirectly using the WAP as the wireless connection means. When connected, the user device allows a user to wirelessly communicate both internal and external telephone calls, radio phone calls, or data transmissions using the system. Such telephone calls, radio calls, or data transmission may also include voicemail services.

Advantageously, the external gateway comprises a cellular gateway and/or voice-over-IP gateway (VoIP gateway) to connect the IP phone unit to an external communications network. The user device is typically a digital telephone, personal computer, portable computer, handheld computer, Blackberry™ device, Palm® device, radio phone, or facsimile. Moreover, the user device may be any type of electronic device capable of communicating telephone calls, radio phone calls, and/or data transmissions within the system either directly, using its own wireless connection means, or indirectly using a WAP as the wireless connection means.

In another aspect of the invention, a method is disclosed for wirelessly providing telephone calls, radio phone calls, and data transmissions both internally and with the outside world using an integrated telecommunication system that may be transported to and setup at remote locations. The method comprises the steps of providing an IP phone unit, external gateway, and WiFi network host disposed within a housing, connected in an operative relationship, and provided with a source of power. Next, a user device wirelessly connects to the WiFi network host either directly, using its own wireless connection means, or indirectly using a WAP as the wireless connection means, whereby wireless communication services are provided without the need for a hard-wired connection to an external communication system or hard-wired connections between the internal user devices. Such wireless communication services comprise telephone calls, radio phone calls, or data transmissions, which in turn may also include voicemail services.

### BRIEF DESCRIPTION OF THE DRAWINGS

FIG. 1 is a perspective view of a wireless communication system housing according to a preferred embodiment of the invention.

FIG. 2 is a front elevation of an interior layout of a wireless communication system with a front panel removed, according to a preferred embodiment of the invention.

FIG. 3 is a schematic diagram showing a more detailed view of the various components of a wireless communication system according to a preferred embodiment of the invention.

FIG. 4 is a perspective view of a construction site trailer incorporating a wireless communication system in an exemplary application according to a preferred embodiment of the invention.

FIG. 5 is a flow chart illustrating a method for using a wireless communication system according to a preferred embodiment of the invention.

### DETAILED DESCRIPTION OF THE PREFERRED EMBODIMENTS

The invention provides a rugged, portable, integrated wireless telephone and data system that can be transported to a remote site, whereby wireless communication and data transfer is established internally and with the outside world. Such external communication is possible using a variety of means such as, for example, a cellular gateway or VoIP gateway. Internal communication is accomplished using an IP phone unit capable of wirelessly connecting to a variety of user devices, such as digital telephones, radio phones, personal computers, facsimiles, and the like. In the embodiments discussed herein, the system gives users the capability of communicating telephone calls, radio calls, and data transmissions.

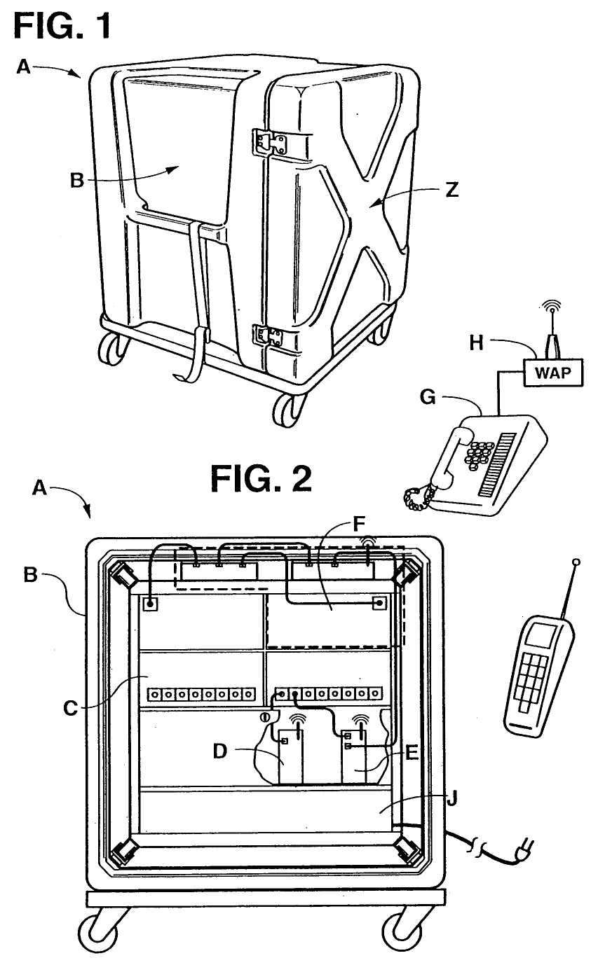

FIG. 1 indicates an exterior view of a preferred embodiment of the invention, wherein a mobile, full-service, wireless telephone and data system, designated generally as A, is illustrated. As illustrated, the system includes an exterior housing B and exterior panel Z, which are both made of rugged plastic comprising an outer shell mounted on wheels for transporting the entire system to remote locations. Exterior panel Z is fixed in place and the system is shown ready for transport.

FIG. 2 indicates an interior view of a preferred embodiment of the invention, wherein the major components of wireless telephone and data system A are illustrated. Exterior cover Z is shown removed so that one may view the interior components of wireless telephone and data system A. FIG. 2 indicates a preferred embodiment comprising: a rugged exterior housing B, an IP phone unit C, a cellular gateway D, a VoIP gateway E, a WiFi network host F, a user device G, a WAP H, and an AC power supply and conditioner J.

When wireless telephone and data system A is connected to an AC power source, cellular gateway D and VoIP gateway E power on, search for, and establish links with a local cellular and Internet network providers. WiFi network host F searches for and establishes a link with internal WAP H connected to user device G in the immediate area. Once fully connected, IP phone unit C is then capable of communicating telephone calls, radio calls, and data transfers both internally and externally.

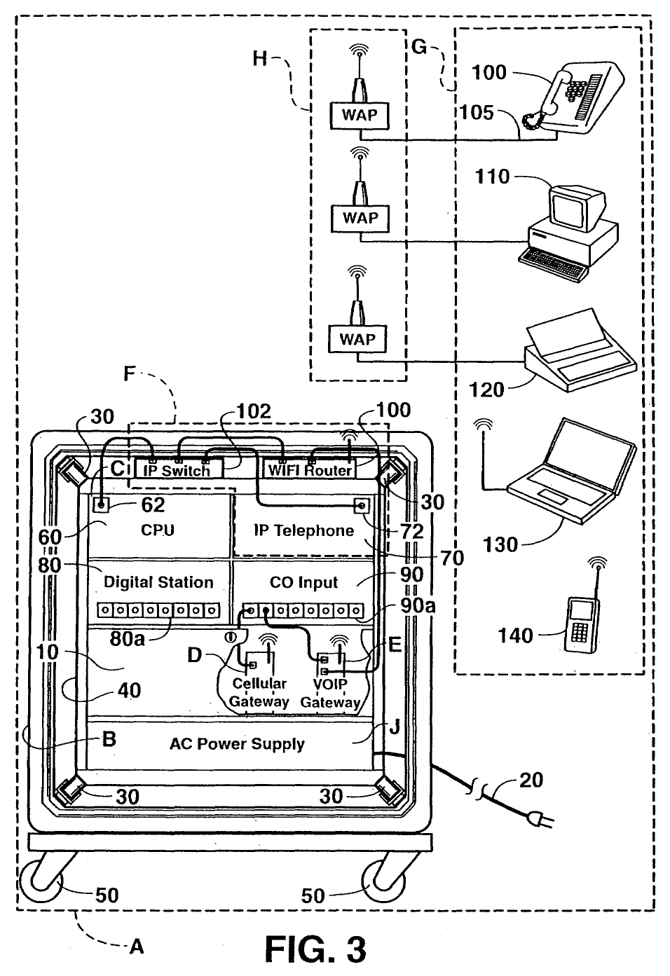

Interconnection of the various system components of a preferred embodiment are shown in FIG. 3, wherein wireless telephone and data system A is illustrated. In addition to the components shown in FIG. 2, the wireless telephone and data system A further comprises a lockable storage drawer 10, AC power cord 20, rubber mounts 30, data rack 40, and wheels 50.

Exterior housing B is mounted on four individual wheels 50 for transporting the entire system to remote locations. Enclosed within housing B are eight rubber mounts 30 to provide shock absorption during transport. The major system components are suspended by rubber mounts 30 to better protect each from harsh shipping and handling. Data rack 40 is mounted within exterior housing B and attached directly to rubber mounts 30 at each corner. The major system components—IP phone unit C, cellular gateway D, VoIP gateway E, WiFi network host F, and AC power supply J—are mounted within data rack 40 so that system A is protected during transportation and use at remote locations. These major components are interchangeable and the system is also expandable so that it may also include other devices such as voicemail cards.

As illustrated in FIG. 3, IP phone unit C is an IP-capable telephone system with four interchangeable module bays, housing the following modules: central processing unit (CPU) 60, IP telephony 70, digital station 80, and central office (CO) input 90. These modules give IP phone unit C tremendous versatility, including: two rows of telephone line connectors, which can connect any combination of eight telephone trunk lines, sixteen wireless IP user devices, eight hard-wired digital telephones, and/or eight voice mail ports. IP phone unit C may be any suitable telephone system, such as the Toshiba CTX 200 telephone system available from Toshiba America of Irvine, Calif. In accordance with a preferred embodiment of the present invention, the telephone system is configured with the four modules described above, which are also available from Toshiba America. Although a Toshiba model is used, a preferred embodiment may instead use any standard telephone system that includes IP telephony capabilities.

CPU module 60 stores user configurations and controls the overall operation of IP phone unit C. Users may program IP phone unit C by connecting a computer (not shown) to CPU module 60 directly through Ethernet port 62 or wirelessly, as shown in FIG. 3, by connecting through WiFi router 100 and IP switch 102.

IP telephony module 70 converts analog or digital telephone calls and data communications to Internet protocol for transfer within system A. As illustrated in FIG. 3, wireless communication is routed through IP telephony module 70 with an Ethernet cable connected to IP switch 102, then with a separate Ethernet cable to WiFi router 100. Internal telephone calls and data transmissions are routed in this manner and need not employ outside gateways.

If users prefer instead to connect internal user devices directly to IP phone unit C, up to eight hard-wired user devices, such as digital PBX or key system-type telephones, may be connected to digital station module 80 at inputs 80a, as long those user devices are designed for use with the specific model of IP phone unit C used. No digital telephones are connected in this embodiment because a primary purpose of the system is to eliminate the need for hard-wired connection of user devices.

CO input module 90 allows connection of telephone trunk lines capable of providing a dial tone and communication with the outside world. There are eight inputs 90a, each capable of connecting a separate telephone or data line to IP phone unit C. As shown, cellular gateway D and VoIP gateway E are connected to two of the eight inputs and each provide a separate telephone service line to IP phone unit C. If required, users may add up to six additional gateways for each additional phone or data line needed.

A person of ordinary skill in the art would understand that the external gateways of telephone and data system A would not be limited to the cellular and VoIP means shown in this embodiment, but may instead be comprised of any wireless gateway capable of connecting telephone and data system A to external communication systems. Moreover, IP phone unit C may also utilize a hard-wired connection to the POTS, if conveniently available; but preferred embodiments would forego hard-wired connections because a primary object of the invention is to eliminate the need for hard-wired connections.

As illustrated in FIG. 3, cellular gateway D is connected to CO input module 90 to provide IP phone unit C with external telephone and data access. Cellular gateway D provides a standard telephone connection and may also be used to provide both low-speed Internet access and radio phone capabilities through interconnection with various cellular carriers, such as Cingular, T-Mobile, Nextel, Verizon, and the like. The Nextel cellular gateway shown is capable of sending and receiving: telephone calls, some data transmissions (such as facsimile service), low-speed Internet access, and Nextel's 2-way radio phone calls. In fact, the Nextel gateway is preferred because the Nextel radio phone has become an industry standard in the construction industry.

FIG. 3 also shows VoIP gateway E, which is likewise connected to CO input module 90 to provide IP phone unit C with an additional external telephone and data access. Similar to cellular gateway D, VoIP gateway E provides a standard telephone connection to IP phone unit C. But unlike cellular gateway D, VoIP gateway E also provides high-speed Internet access directly to system A through connection of an Ethernet cable to WiFi router 100. VoIP gateway E as shown is capable of sending and receiving telephone calls over the Internet using voice-over-IP technology.

In a typical embodiment, VoIP gateway E comprises a wireless means of accessing an Internet portal, such as a standard wireless card. The wireless card should be capable of connecting to high-speed Internet access in a many ways, including local WiFi hot spots, such as seen in many local coffee shops, and local wide-area Internet, such as seen in Verizon's BroadbandAccess service. The high-speed Internet output of the wireless card would feed directly to a standard VoIP modem, which translates Internet protocol into voice for connection to CO input module 90. The high-speed Internet output of the wireless card would also feed directly to WiFi router 100 to provide high-speed Internet access to user devices G that are capable of connecting to WiFi router 100.

FIG. 3 also indicates a number of user devices G capable of internal connection to telephone and data system A. User devices G may incorporate full-feature capabilities, such as voicemail, transfer, and conference capabilities, or the like, depending upon the specific type of user device utilized. User devices can be any of a number of electronic devices, such as digital telephone 100, personal computer 110, facsimile 120, laptop computer, 130, cellular and radio telephone 140, a handheld computer, a Blackberry™ device, a Palm® device, or the like. As shown, digital telephone 100, personal computer 110, and facsimile 120 each communicate with IP phone unit C through WiFi network host F using an individual WAP H. Other user devices, however, such as laptop computer 130 and cellular and radio telephone 140 already possess wireless communication means that are capable of communicating with IP phone unit C, either through WiFi network host F or one of the external gateways.

If WAP H is required, communication to and from a user device is typically routed in the following manner. When connected, WAP H establishes a wireless link to WiFi router 100, whereby telephone calls and data communications are transferred using wireless IP. As illustrated in FIG. 3, wireless communication is routed through IP telephony module 70 with an Ethernet cable connected to IP switch 102, then with a separate Ethernet cable to WiFi router 100, then wirelessly to WAP H, and finally through a digital cable 105 to user device G. WAP H may be any standard wireless access point, such as the commonly available models from D-Link®.

As with any communication system, a clean alternating current supply is essential. Thus as further illustrated in FIG. 3, AC power supply J provides AC power to the components contained in housing B. Because remote AC power sources are often full of electrical noise, interference, and power surges, AC power supply J also contains a power conditioner to rectify such problems and provide a clean AC power supply to the components of system A.

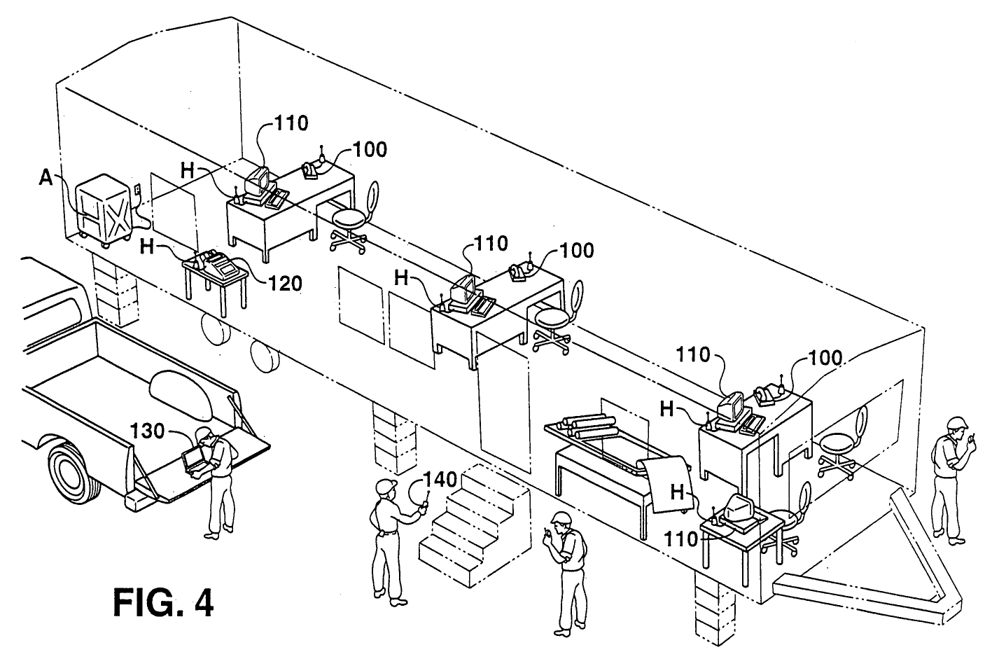

FIG. 4 indicates one configuration that may be employed in a preferred embodiment of the invention. A typical remote work site trailer 400 is shown containing telephone and data system A and many of the various user devices one may use to communicate within system A. Once transported to the remote site, telephone and data system A is connected to an AC power source as shown. Upon activation, system A begins connecting to the various WAPs H within range. FIG. 4 illustrates the placement and connection of many WAPs H used to connect digital telephones 100, personal computers 110, and facsimile 120 inside trailer 400. System A also connects wirelessly to other user devices, such as laptop computer 130 and cellular and radio telephones 140. Once connected, each user device may be used to wirelessly communicate telephone calls, radio calls, and data transfers as appropriate to each respective device.

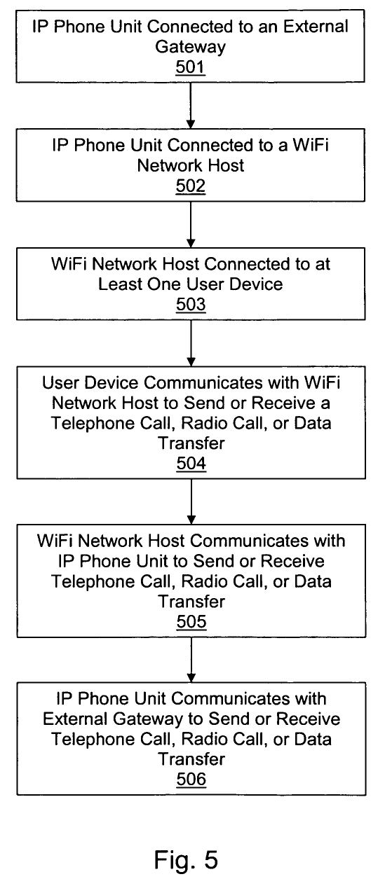

FIG. 5 is a flowchart of connection method 500 indicating a preferred method for communicating using the invention, wherein an internal user device communicates with an external source through the system when connected to an external gateway. In this preferred embodiment, a manufacturer, dealer, or user first connects an IP phone unit to an external gateway at 501. The IP phone unit now has access to the outside world using the external gateway, which is generally a cellular gateway or VoIP gateway but may be any type of wireless gateway that capable of connecting the IP phone unit to an outside communication system.

The IP phone unit is then connected to a WiFi network host at 502 to give the IP phone unit access to internal devices using wireless IP. The WiFi network host is then connected to at least one user device at 503. User devices may be any type of wireless device capable of communicating with the WiFi network host, such as a digital telephone, wireless radio, computer, or the like.

Once the system components are in place, at 504 the user device communicates with the WiFi network host to send or receive a telephone call, radio call, or data transfer. That communication is then transmitted within the system at 505 from the WiFi network host to the IP phone unit. Once received by the IP phone unit, at 506 the communication is further transmitted to the outside world using the external gateway. In this way, the telephone call, radio call, or data transfer is communicated to or from the outside world all the way to the internal user without the need for hard-wired connections between the outside world and a preferred embodiment of the system.

These embodiments of the present invention overcome the above-identified and other deficiencies in conventional telephone systems by providing a rugged, portable, integrated wireless system and method to allow users to send and receive telephone calls, radio calls, and data transmissions in a remote location without the time and expense of connecting to the POTS.

These examples are offered by way of illustration of the invention's versatility and not meant to limit the invention in any way. The present invention may be embodied in other specific forms without departing from its spirit of essential characteristics. The described embodiments are to be considered in all respects only illustrative and not restrictive. The scope of the invention is, therefore, indicated by the appended claims, rather than by the foregoing description. All changes which come within the meaning and range of equivalency of the claims are to be embraced within their scope.

1. An integrated telecommunication system that may be transported to and setup at remote locations for wirelessly providing telephone, radio phone, and data service from the outside world, said system comprising:
a portable housing;
an Internet protocol-enabled phone unit disposed in said housing;
an external gateway disposed in said housing and connected to said Internet protocol-enabled phone unit for wirelessly communicating telephone calls, radio phone calls, and data transmissions to and from said Internet protocol-enabled phone unit and an external communications network;
a WiFi network host disposed in said housing and connected to said Internet protocol-enabled phone;
a wireless access point for communicating one or more of a telephone call, radio phone call, and data transmission to and from said WiFi network host;
a user device connected to said wireless access point, wherein said one or more of a telephone call, radio phone call, and data transmission is wirelessly communicated to and from said user device and said wireless access point.

2. The system of claim 1, where said external gateway comprises one of a cellular gateway and VoIP gateway.

3. The system of claim 1, wherein said user device comprises one of a digital telephone, personal computer, portable computer, handheld computer, Blackberry™ device, Palm® device, radio phone, and facsimile.

4. The system of claim 1, wherein said user device comprises an electronic device for directly communicating with said WiFi network host or indirectly communicating with said WiFi network through said wireless access point.

5. The system of claim 1, wherein said housing is made of protective material and includes wheels for moving said housing over a floor.

6. The system of claim 1 including a data rack for mounting or placing said Internet protocol-enabled phone unit, external gateway, and WiFi network host within said housing.

7. The system of claim 1 including shock absorbing mounts for mounting said data rack within said housing.

8. The system of claim 1 wherein said housing includes a removable closure.

9. The system of claim 1 including a storage drawer disposed within said housing.

10. The system of claim 1 wherein one of said telephone calls, radio phone calls, and data transmissions comprises voicemail.

11. An integrated telecommunication system that may be transported to and setup at remote locations for wirelessly providing at least one of a telephone, radio phone, and data service to and from the outside world, said system comprising:
an Internet protocol-enabled phone unit;
an external gateway connected to said Internet protocol-enabled phone unit, for wirelessly communicating one of a telephone call, radio phone call, and data transmission to and from said Internet protocol-enabled phone unit;
a WiFi network host connected to said Internet protocol-enabled phone unit for connecting with at least one wireless user device and communicating said one of a telephone call, radio phone call, and data transmission to and from said Internet protocol-enabled phone unit and said user device.

12. The system of claim 11, where said external gateway comprises a cellular gateway or VoIP gateway.

13. The system of claim 11, wherein said user device comprises one of a digital telephone, personal computer, portable computer, handheld computer, Blackberry™ device, Palm® device, radio phone, and facsimile.

14. The system of claim 11, wherein said user device comprises an electronic device for directly communicating with said WiFi network host or indirectly communicating with said WiFi network through a wireless access point.

15. The system of claim 11, wherein said Internet protocol-enabled phone unit, external gateway, and WiFi network host are enclosed within a housing.

16. The system of claim 15, wherein said housing is made of protective material and includes wheels for moving said housing over a floor.

17. The system of claim 15, wherein said housing includes a removable closure.

18. The system of claim 15 including a storage drawer disposed within said housing.

19. The system of claim 15 wherein said one of telephone call, radio phone call, and data transmission comprises voicemail.

20. The system of claim 11 including a data rack for mounting or placing said Internet protocol-enabled phone unit, external gateway, and WiFi network within a housing.

21. The system of claim 11 including shock absorbing mounts for mounting said data rack within said housing.

22. The system of claim 11 further comprising an alternating current supply and power conditioner.

23. A method of wirelessly providing one of a telephone, radio phone, and data service to and from the outside world using an integrated telecommunication system that may be transported to and setup at remote locations, said method comprising the steps of:
providing an Internet protocol-enabled phone unit, external gateway, and WiFi network host disposed within a housing and connected in an operative relationship;
connecting said Internet protocol-enabled phone unit, external gateway, and WiFi network host to a power source;
accessing a user device that is wirelessly connected to said WiFi network host, wherein said wireless connection is accomplished directly or accomplished indirectly through a wireless access point;
whereby wireless communication services are provided without the need for a hard-wired connection to an external communication system.

24. The method of claim 23, wherein said user device comprises one of a digital telephone, personal computer, portable computer, handheld computer, Blackberry™ device, Palm® device, radio phone, and facsimile.

25. The method of claim 23, wherein said housing is made of protective material and includes wheels for moving said housing over a floor.

26. The method of claim 23 further comprising the use of a data rack for mounting said Internet protocol-enabled phone unit, external gateway, and WiFi network within said housing.

27. The method of claim 23 further comprising the use of shock absorbing mounts within said housing.

28. The method of claim 23, wherein said housing includes a removable closure.

29. The method of claim 23 further comprising the use of a storage drawer disposed within said housing.

30. The method of claim 23 wherein said wireless communication services comprise voicemail.

31. A method of wirelessly providing one of a telephone, radio phone, and data service from the outside world using an integrated telecommunication system that may be transported to and setup at remote locations, said method comprising the steps of:
providing an Internet protocol-enabled phone unit connected to an external gateway;
providing a WiFi network host connected to said Internet protocol-enabled phone unit;
providing a user device wirelessly connected to said WiFi network host, wherein said wireless connection is accomplished directly or accomplished indirectly through a wireless access point;
whereby a user may send or receive one or more of a telephone call, radio call, and data transfer using said user device.

32. The method of claim 31, where said external gateway comprises one of a cellular gateway and VoIP gateway.

33. The method of claim 31, wherein said user device comprises one of a digital telephone, personal computer, portable computer, handheld computer, Blackberry™ device, Palm® device, radio phone, and facsimile.

34. The method of claim 31, wherein said Internet protocol-enabled phone unit, external gateway, and WiFi network host are enclosed within a housing.

35. The method of claim 34, wherein said housing is made of protective material and includes wheels for moving said housing over a floor.

36. The method of claim 34, wherein said housing includes a removable closure.

37. The method of claim 34 further comprising the use of a storage drawer disposed within said housing.

38. The method of claim 35 wherein said one or more of a telephone call, radio call, and data transfer comprises voicemail.

39. The method of claim 31 further comprising the use of a data rack for mounting or placing said Internet protocol-enabled phone unit, external gateway, and WiFi network host within a housing.

40. The method of claim 31 further comprising the use of shock absorbing mounts.

41. The method of claim 31 further comprising the use of an alternating current supply and power conditioner.
